(19) United States
(12) Patent Application Publication
(10) Pub. No.: US 2025/0305768 A1
(43) Pub. Date: Oct. 2, 2025

(54) WASTE HEAT INTEGRATED RECOMPRESSION

(71) Applicant: Charles Thomas Tucker, Jr., Madison, WI (US)

(72) Inventor: Charles Thomas Tucker, Jr., Madison, WI (US)

(21) Appl. No.: 18/773,072

(22) Filed: Jul. 15, 2024

Related U.S. Application Data
(60) Provisional application No. 63/571,226, filed on Mar. 28, 2024.

(51) Int. Cl. F26B 25/00; F26B 23/00

(52) U.S. Cl. CPC F26B 25/005; F26B 23/004; F26B 2200/02

(57) ABSTRACT

Systems and methods of improved exhaust heat recovery for using industrial facilities and plants such as those pertaining to ethanol, seed oil extraction and papermaking are described wherein a heat recovery working fluid makes direct contact with the exhaust gases, such as from a bio mass dryer or thermal oxidizer in an ethanol, paper mill or seed oil extraction plant. The heat from the working fluid is used to create a relatively low pressure, low temperature process steam that relative to other facility process streams, in a flash receiver that can be compressed to elevate the temperature and pressure to a level suitable for a greater variety of facility process applications.

### CROSS-REFERENCE TO RELATED APPLICATIONS

This application claims priority to and incorporates by reference U.S. Patent Provisional Application No. 63/571,226 filed on Mar. 28, 2024 and entitled Waste Heat Integrated Vaper Compression and having the same inventor as the present application.

### BACKGROUND

There is an increasing focus on energy efficiency in industrial facilities for operating cost reduction and to minimize the emission of greenhouse related gases such as carbon dioxide. It is well known that many agricultural industrial processes use dryers in the processing of agricultural products, and that these dryers require a significant amount of energy to remove moisture from the materials being dried. It is also well known that the exhaust gases from the dryer contain a significant portion of the energy that was input to remove the moisture from the material being dried, and that much of the energy input into drying is contained in the resulting water vapor in the dyer exhaust. In the cases where thermal oxidizers are used to eliminate potentially harmful pollutants from the dryer exhaust, it is also known that a significant amount of thermal energy input by the dryer is released to the environment through the thermal oxidizer exhaust, though the percent volume of exhaust moisture may be somewhat reduced due to the non-condensable gases added during thermal oxidation.

In the production of ethanol, a biomass called distillers grains is produced as a co-product wet cake. Many alcohol facilities use rotary, steam tube or ring dryers to remove moisture from the wet-cake to make it suitable for longer storage prior to use as animal feed, to reduce its weight prior to transfer off site, to make it suitable as a bio-fuel, or for some other beneficial use. In the removal of seed oil from materials such as soybeans, canola, sunflower seeds, cottonseeds and peanuts, after the oil is extracted using hexane as an oil solvent, the resulting biomass meal is processed in a desolvantizer-toaster (DT) to recover residual hexane from the (biomass) meal and to ready the meal for some other beneficial use such as animal feed or fertilizer. After the hexane is removed in the DT section, the meal passes to the dryer-cooler (DC) section where residual moisture in the meal is removed prior to cooling. The desolvantizer-toaster (DT) section may be physically integrated with the dryer-cooler (DC) within the same housing, in which case the device is termed the DTDC, or the dryer-cooler may be constructed separately from the desolvantizer-toaster (DT) and simply termed “DC”. Larger systems tend to have a separate DC section, but the function of the DC and application of the invention are identical in either case. In the removal of water from pulp stock in papermaking, the mechanically dewatered sheet passes to one or a series of dryers that increases the pulp solids from about 28 percent to about 97 percent, the percentages varying depending on the type of paper produced.

Drying operations generally use ambient air added to the dryer with a fan and heated with a gas fired burner, steam or hot water to allow moisture removal by evaporation of the water into the heated air. In the drying of wet-cake from ethanol production and the drying of meal from seed oil extraction, the dryer produces a dried cake or meal. In the drying of a pulp stock in papermaking, the dried pulp is a direct paper product. In all cases the dryer also produces hot and humid exhaust gases that are generally released directly to the environment directly, after processing with a cyclone to remove particulates, or possibly a thermal oxidizer to eliminate constituents that are not suitable for release to the atmosphere.

U.S. Pat. No. 11,439,924 B2, which is fully incorporated herein by reference, describes the use of direct contact heat recovery and waste heat to remove water from the thin stillage produced as a part of ethanol production. Whole stillage from distillation is processed in decanters designed to separate suspended solids and water. The water still contains some solids and is called Thin Stillage. This patent teaches about direct contact evaporation, using air, exhaust such as from a dryer, and liquids are brought into intimate contact using a direct contact, open column designed evaporator to evaporate a portion of the water from the bulk liquid stream. Waste heat is sometimes needed to preheat the gases, and may supplied by dryer exhaust, boiler exhaust or some other source.

U.S. Pat. No. 3,131,035 describes the recovering heat from dryer exhaust gases after the gases have passed through an incinerator, and using this heat to preheat the bulk dryer exhaust gases going to the incinerator. The patent also teaches of a liquid resulting from the biomass drying being incorporated into the evaporation of process liquids.

U.S. Pat. No. 8,429,832 describes the use of waste heat from a dryer being captured and used in the production of steam for the dryer.

U.S. Pat. No. 10,345,043 describes method for recovering heat from biomass dryer exhaust. The patent acknowledges limitations to the application of the recovered heat in prior art due to the composition of gases that have been in direct contact with wet biomass. The patent also teaches heat recovery using an indirect heat exchanger that keep the dryer exhaust and working fluid, boiler steam condensate or feedwater, from coming in direct contact. The patent also teaches that boiler quality feedwater that is largely contaminant free and that is compatible with similar fluids in the balance of the plant can be used in the indirect heat exchanger, and combined with a flash vessel and a thermal vapor recompressor to elevate the pressure and temperature of the boiler water quality flash vapors to a point where they can be used in the balance of the plant. The patent further teaches that this eliminates concerns for contaminating the boiler feedwater or boiler steam, or the corrosion damage that would result from using working fluids in a boiler steam system that have been in direct contact with dryer exhaust.

U.S. Pat. No. 10,859,257, a continuation of U.S. Pat. No. 10,267,511, teaches that once the indirect method of heat recovery from dryer exhaust is applied, the dryer exhaust passes through a direct contact heat exchange device, where the flash tank method described U.S. Pat. No. 10,345,043 may also be applied using a thermal vapor recompressor. However, the method produces a process steam that is not compatible with boiler steam, boiler feedwater or boiler steam condensate in the balance of the plant.

International Patent No. CN 203586733U describes heat recovery and deodorization of exhaust gases from a desolvantizer-toaster-dryer-cooler (DTDC). The dryer exhaust gases pass from the cyclone common on the dryer outlet, to a “heat recovery and deodorizing device” that incorporates a “shell” containing plates, presumably for indirect contact heat transfer to a liquid that can then be pumped to the balance of the plant for heat recovery in an unspecified manner, and sprays that act as a scrubber to remove foul odors.

While there has been good progress as recognized by the above referenced patents, experience in the United States, South America and Europe indicates that there is a need for an improved method of exhaust energy recovery in ethanol and seed oil extraction facilities. Electricity and thermal energy costs can and do vary significantly from one location to another. Thus, an improved method of exhaust energy recovery should also provide flexibility in its application to best serve the economic circumstances at a particular facility.

There is also a need to have improved methods of exhaust energy recovery in ethanol and seed oil extraction facilities that costs less to construct, install, operate and/or maintain relative to other known systems of similar capacity and/or process size. Indirect heat exchange using a boiler quality working fluid, a flash tank and thermal vapor recompressors prevents the contamination of the boiler system working fluids, but indirect heat exchange is expensive, requires more maintenance, and is less effective than direct contact heat exchange because of the greater temperature driving forces required due to existence of tubes, plates or other shapes that make the exchange indirect.

Additionally, since the indirect heat exchangers use relatively closely spaced surfaces to keep contaminated exhaust and the working fluid separate, indirect heat exchangers are more prone to fouling and plugging due to the residual solids and other contaminants that are often in process exhaust. Cyclones can be used to remove some of the solids entrained in the dryer exhaust in some cases, but in others the sticky nature of the materials would cause plugging and heat recovery system downtime.

### SUMMARY

Embodiments of ethanol, papermaking, and seed oil extraction systems, processes, and methods with improved exhaust heat recovery are provided that use direct contact heat recovery between the exhaust gases from a biomass dryer or thermal oxidizer in an ethanol or seed oil extraction plant, and use this heat to create a low pressure and low temperature process steam in a flash receiver that may be too low to be of use to heat other streams in the plant, but can be subsequently compressed to elevate the temperature and pressure to a level suitable for facility process applications.

Accordingly, embodiments of improved ethanol and seed oil extraction plant designs, processes, and methods with direct contact exhaust heat recovery are provided that use dryer or oxidizer exhaust heat to create a low pressure and low temperature process steam in a flash receiver that includes mechanical vapor recompression (MVR), thermal vapor recompression (TVR) or a combination thereof, to increase the temperature and pressure of the low pressure process steam to a level that makes it more widely useful to reduce the energy use of the plant processes, that is otherwise met through use of primary (non-waste heat) energy like electricity, natural gas, wood or coal.

Accordingly, embodiments of improved ethanol and seed oil extraction plant designs, processes, and methods with direct contact exhaust heat recovery are provided that allow the adaptation of the method of vapor recompression of the low pressure process steam generated in the flash receiver to use an electric motor driven MVR, a boiler quality steam pressure let-down turbine driven MVR, a steam-operated TVR, or a combination thereof to reduce the overall cost of operating the exhaust energy recovery system.

The described embodiments also include a method to use the heat recovered from the exhaust gases to thermally reduce the volume of process wastewater discharge from the plant, while recovering the water removed as a vapor or liquid for direct process use, or as a liquid to be further refined for use in boiler steam systems.

The improved ethanol and seed oil extraction plant designs, processes and methods embodied herein provide a means to adapt the vapor recompression portion of the exhaust heat recovery system to the energy cost needs of any particular facility that is relatively simple, cost effective, and minimizes maintenance compared to systems that utilize indirect heat exchangers with tubes, plates, or some other physical barrier between the dryer exhaust gases and the working fluid.

Embodiments describe the application of direct contact heat recovery to directly transfer the heat contained in dryer or oxidizer exhaust gases to a working fluid, such as process condensate, that is then provided to a flash receiver at a lower pressure, whereby the recovered heat causes flash vapor to form, which is then a low pressure process steam. The low pressure process steam created in the flash receiver, in whole or in part, is subsequently compressed with electric MVR, a boiler steam turbine driven MVR, a TVR, or a combination thereof to elevate the temperature and pressure of the process steam so that it can then be used to reduce the energy requirements of the plant that would otherwise be provided by primary (non-waste heat) energy such as electricity, natural gas, wood or coal. Additionally, the higher temperature and pressure process steam may be used to thermally reduce process wastewater volume through evaporation, and the vapor used directly in facility processes, condensed to a liquid phase and used directly in facility processes, or condensed to a liquid phase and subsequently refined for use in facility areas that require cleaner water.

The Summary presented above is not to be considered limiting as to the overall scope of the invention. Rather, the Summary as presented herein recites the features, elements, and advantages of only a select portion of the method and system embodiments that are contemplated as a result of the point(s) of novelty presented and enabled herein.

### BRIEF DESCRIPTION OF THE DRAWINGS

Various examples of embodiments of the systems, devices, and methods according to this invention will be described in detail, with reference to the following figures. Embodiments other than the specific examples illustrated in the figures are possible.

FIG. 1 depicts an example whereby heat is recovered from dryer or thermal oxidizer exhaust in a direct contact heat exchanger using process condensate or another process liquid that is not boiler steam condensate or boiler feedwater, as the working fluid according to an embodiment of the present invention.

FIG. 2 depicts an example whereby heat is recovered from dryer or thermal oxidizer exhaust in a direct contact heat exchanger using process condensate or another process liquid as the working fluid according to an embodiment of the present invention.

FIG. 3 depicts an example whereby heat is recovered from dryer or thermal oxidizer exhaust in a direct contact heat exchanger using process condensate or another process liquid that is not boiler steam condensate or boiler feedwater, as the working fluid according to an embodiment of the present invention.

FIG. 4 depicts an example whereby heat is recovered from dryer exhaust in a direct contact heat exchanger using process condensate or another process liquid that is not boiler steam condensate or boiler feedwater, as the working fluid according to an embodiment of the present invention.

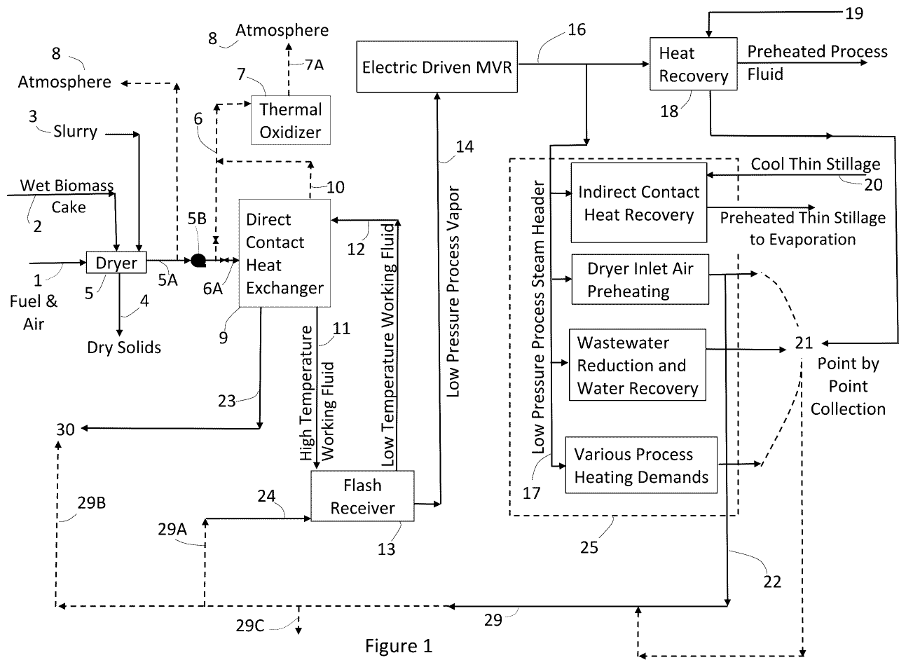

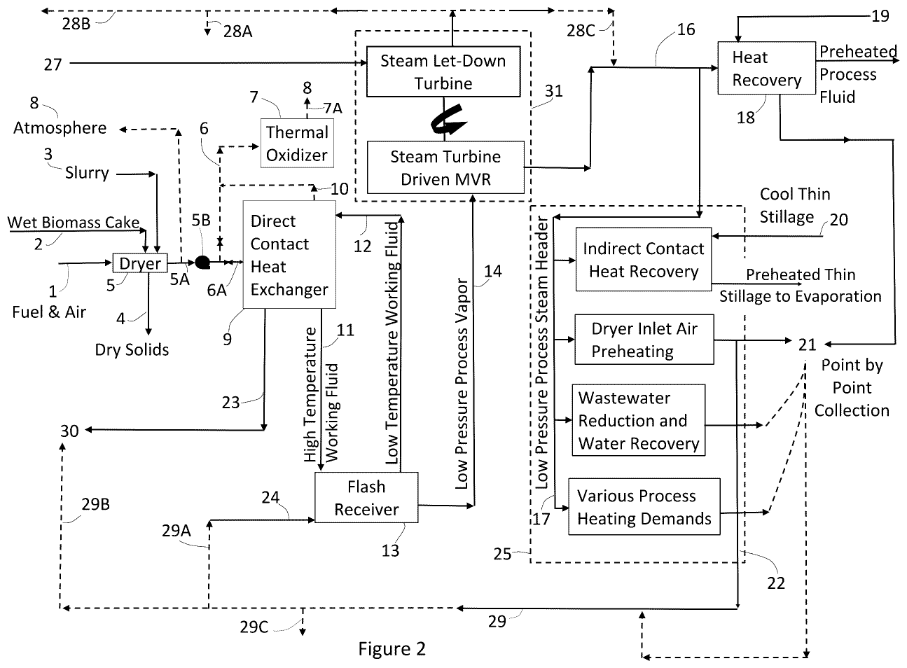

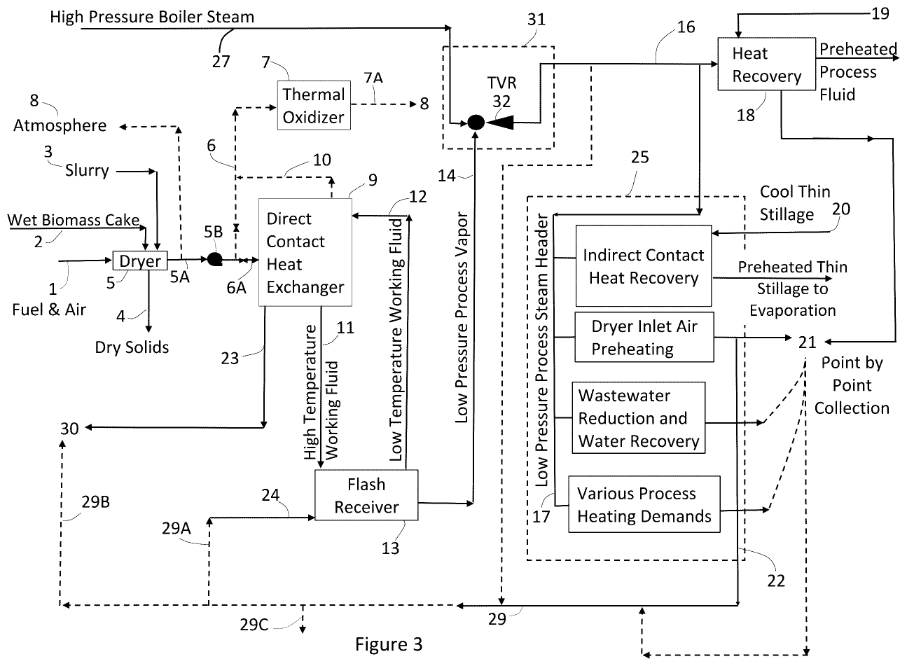

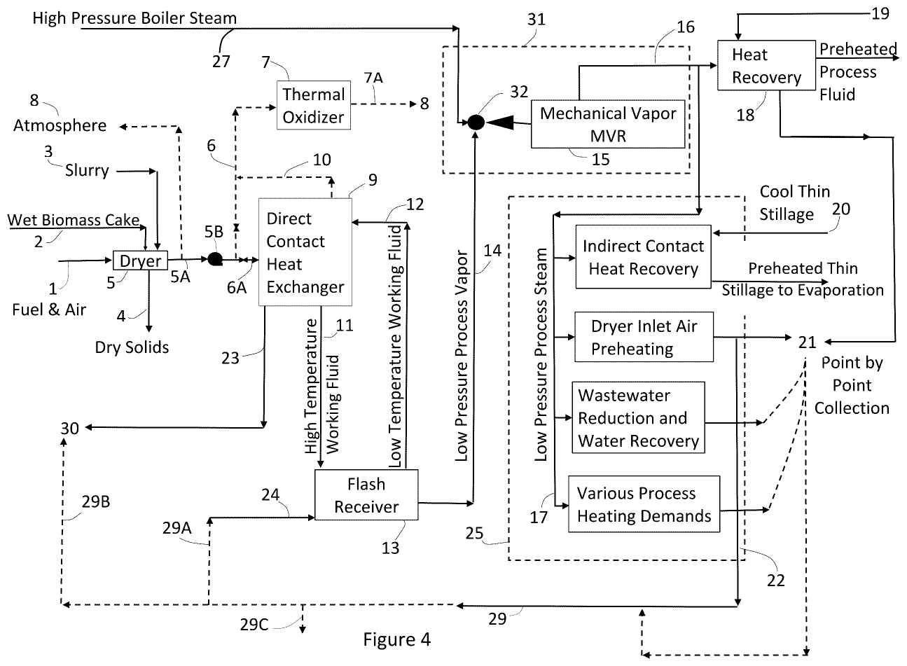

It should be understood that the drawings are not to scale. In certain instances, details that are not necessary to the understanding of the invention or that render other details difficult to perceive have been omitted. It also should be understood, of course, that the invention is not necessarily limited to the particular embodiments illustrated in FIG. 1, FIG. 2, FIG. 3, or FIG. 4.

### DETAILED DESCRIPTION

### Overview

Several specific embodiments are described. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of the design, fabrication, and manufacture for those of ordinary skill having the benefit of this disclosure.

In a typical ethanol production, seed oil extraction or similar agricultural process, a dryer such as a spray dryer, a ring dryer, a steam tube dryer or rotary drum dryer is used to remove moisture from a biomass. The biomass may be from any number and type of processing operations, that is then supplied to a dryer as a meal or cake, a biomass that contains solids and moisture, and also sometimes as a “slurry”, a liquid composition that is predominantly water and solids from the same or another part of a process. A slurry will generally flow much more readily than will a cake or meal. Thus, when a slurry is added, it is generally mixed with the meal, cake or some other binder prior to entering the dryer to allow better control over the movement of liquid water.

Prior art dryers and dryers used in the described embodiments generally, but not necessarily, operate with heated inlet air at a temperature between 200° F. and 800° F., and sometimes under vacuum. The high temperature, and vacuum when used, increases the vapor pressure difference so that the liquid water in the meal, cake or slurry is more easily converted to a vapor in the heated air, which is then drawn from dryer, typically with an exhaust fan. The exhaust, composed predominantly of non-condensable gases, other condensable gaseous contaminants, and moisture, may be discharged to a cyclone separator and then to (1) the atmosphere as is common in seed oil extraction, (2) a thermal oxidizer as is common in ethanol production, or (3) process applications in another part of the plant where the heat in the exhaust is beneficially used at the temperature at which it is available. No matter where the exhaust is directed upon exiting prior art dryers, it is usually hot and moisture laden, and contains a significant amount of thermal energy.

In many known industrial operations, while the exhaust contains a significant amount of thermal energy, it is often at too low of a temperature and pressure relative to the needs of the facility so that its utility as an effective heat source is limited. For example, many drying applications exhaust at less than 215° F. even when the air entering the dryer is heated to 800° F. The reason is that the thermal energy in the heated air serves to evaporate water from the biomass, and is itself cooled as a result. In many known thermal oxidizer applications, such as a regenerative thermal oxidizer (RTO), the exhaust when exiting an oxidizer is less than 330° F., even if the exhaust stream entering the oxidizer is heated to 1,600° F. internally.

The prior art dryer exhaust often contains biomass particulate carryover, and this particulate is often sticky and can clog typical indirect heat exchangers, thus limiting the effectiveness of heat recovery.

Embodiments of the present invention utilize a direct contact heat exchanger that allows direct contact between the dryer exhaust and/or the oxidizer exhaust, and a circulating working fluid, such as a process condensate that is not boiler steam condensate or boiler feedwater. The direct contact heat exchanger may or may not contain internal packing to enhance heat and mass transfer depending on the specific application. The working fluid enters the direct contact heat exchanger cooler than the dewpoint temperature of the dryer exhaust, and at a flow that is determined by the quantity of heat to be recovered. The working fluid passes through the direct contact heat exchanger, and is heated by both sensible and latent heat transfer.

Sensible heat transfer occurs solely as a result of the dryer exhaust temperature dropping without the condensation of water vapor from the exhaust as it is cooled below dew-point. Latent heat transfer occur when the temperature of the dryer exhaust drops below the dew-point temperature of the exhaust, whereby condensation of water vapor from the exhaust occurs and whereby the heat released by the condensing of the water vapor is the latent heat. The quantity of heat available when water vapor condenses is generally far greater than the sensible heat available from temperature change. For example, if the exhaust flow is 50,000 pounds per hour and 1,000 pounds per hour of water vapor is condensed when the dryer exhaust is cooled 1° F. below the its dew-point, to provide the same heat with temperature change only (sensible heat), the temperature of the dryer exhaust would have to drop by about 70° F. Such a temperature drop is often not practical due to the relatively low dryer exhaust temperature, and in any event limits the utility of the exhaust as an effective energy source in the facility.

In the same dryer exhaust stream, if a significant quantity of latent heat is required, it will still be necessary to reduce the temperature of the exhaust far enough below dew-point to recover the latent heat energy that the temperature is is even lower and thus not effective as an energy source in the facility. Thus, there is a need for an effective means to increase the relatively low temperature of the recovered heat to a level that is more useful to reduce energy needs in the facility.

The application of direct contact heat recovery, as used in the embodiments and methods described herein, is a very effective means to recover large quantities of heat from moisture laden exhaust by allowing a relatively cool working fluid to enter at the appropriate flow to satisfy the energy balance required. The working fluid leaves the direct contact heat exchanger at a temperature higher than the entering temperature, and is transferred to a flash receiver connected to a vacuum generating device such as a mechanical vapor recompressor, a thermal vapor recompressor or some combination thereof. The vacuum generating device lowers the pressure in the flash receiver such that the heated working fluid from the direct contact heat exchanger flash boils upon entry, and generates a low pressure vapor. The working fluid is cooled during this process and is then returned to the direct contact heat exchanger to be reheated. The returning working fluid and the lower pressure vapor in the flash receiver are at approximately the same temperature, and are cool relative to the energy needs of the facility. While the lower pressure vapor can have use in certain embodiments, these uses are generally limited due to the relatively low temperature. To address the low temperature, some embodiments utilize the vacuum generating device to compress the low pressure vapor to a higher pressure and elevate its temperature.

Low pressure vapor that leaves the flash receiver through the vacuum generating device must be replaced. The interconnection of the direct contact heat exchanger and flash receiver provides the condensed water vapor from the dryer exhaust as some of the flash receiver makeup. In other embodiments, the flash receiver vapor may also be made up or supplemented from another suitable working fluid source such as process condensate or fresh water that is not boiler steam condensate or boiler feedwater, if heat recovery from thermal oxidizer exhaust is applied.

The system as described above will be referred to by the acronym “WHIR” for Waste Heat Integrated Recompression.

For reference, “low temperature” as used herein generally and specifically as applied to “process vapor” is in comparison to other temperatures that already exist in the associated facility, which are usually but not always higher than the low temperature process vapor from the flash tank. The low temperature process vapor from the flash tank will generally be in the range of 120° F. to 170° F., but may be lower or greater depending on the specific operating conditions of the dryer(s).

### A First Embodiment of a Waste Heate Integrated Recompression System

FIG. 1 depicts one embodiment of the WHIR system, which is a block diagram of the invention as applied to a dryer [5] at an alcohol plant or a seed oil extraction plant. Wet cake, meal or other biomass [2] either alone or mixed with slurry [3] is fed directly to a dryer [5] that is heated with natural gas, coal, wood, electricity or some other energy source [1], typically with some amount of air added to help remove moisture in the form of water vapor. The moisture laden air and other gases removed in the dryer are discharged directly to the atmosphere [8] or drawn through an exhaust draft fan [5B] that discharges [6] to a thermal oxidizer [7] and/or a direct contact heat exchanger [9] depending on whether it is desired to recover heat from a portion or all of the dryer exhaust. The low-temperature working fluid entering the direct contact heat exchanger [9] from the flash receiver is heated by the sensible and latent heat available in dryer exhaust [6A]. Water vapor condensed [23] from the dryer exhaust flows from the direct contact heat exchanger [9] to a suitable collection point for pre-conditioning the dryer exhaust upstream of the direct contact heat exchanger, disposal or refinement for reuse as needed.

The heated working fluid [11] enters the flash receiver [13] at a temperature higher than the working fluid leaving [12] the flash receiver, such that the enthalpy difference provides sufficient energy to convert a portion of the working fluid to low temperature and low pressure process vapor [14].

The low temperature and low pressure process vapor is drawn into a vacuum generating device, in this embodiment, an electric motor driven mechanical vapor recompressor (MVR) [15]. The pressure and temperature of the process vapor is increased by the vacuum generating device, and the resulting compressed vapor [16] is distributed to a heat exchanger [18], which may be direct or indirect contact, to preheat a single process fluid [19], or to a low pressure process steam header for distribution to a multiple of any type of suitable heat loads [25].

Process condensate results when enough heat is recovered from the compressed process vapor that it condenses, converting the vapor to a liquid condensate. The resulting process condensate is collected point by point or combined for collection in a process condensate header [22]. The process condensate can then serve as a makeup source [29A] for the flash receiver via process condensate makeup [24], used for de-superheating the compressed process vapors [16], returned [29B] to the existing facility process condensate collection system or discharged to the facility wastewater treatment plant [29C]. Other options may also exist depending on the specific facility configuration.

### A Second Embodiment of a Waste Heat Integrated Recompression System

In another embodiment of the WHIR system, FIG. 2, which is a block diagram of the invention as applied to a dryer [5] at an alcohol plant or a seed oil extraction plant. Wet cake, meal or other biomass [2] either alone or mixed with slurry [3] is fed directly to a dryer [5] that is heated with natural gas, coal, wood, electricity or some other energy source [1], typically with some amount of air added to help remove moisture in the form of water vapor. The moisture laden air and other gases removed in the dryer are discharged directly to the atmosphere [8] or drawn through an exhaust draft fan [5B] that discharges [6] to a thermal oxidizer [7] and/or a direct contact heat exchanger [9] depending on whether it is desired to recover heat from a portion or all of the dryer exhaust. The low-temperature working fluid [12] entering the direct contact heat exchanger [9] from the flash receiver [13] is heated by the sensible and latent heat available in dryer exhaust [6A]. Water vapor condensed [23] from the dryer exhaust flows from the direct contact heat exchanger [9] to a suitable collection point for pre-conditioning the dryer exhaust upstream of the direct contact heat exchanger, disposal or refinement for reuse as needed.

The heated working fluid [11] enters the flash receiver [13] at a temperature higher than the working fluid leaving [12] the flash receiver, such that the enthalpy difference provides sufficient energy to convert a portion of the working fluid to low-pressure process vapor [14].

The low temperature and low pressure process vapor [14] is drawn to the vacuum generating device [31], in this case, a steam let-down turbine [26] driven mechanical vapor recompressor (MVR) [15]. The pressure and temperature of the process vapor is increased by the vacuum generating device [31], and the resulting compressed vapor [16] is distributed to a heat exchanger [18], which may be direct or indirect contact, to preheat a single process fluid [19], or to a low pressure process steam header [17] for distribution to a multiple of any type of suitable heat loads [25].

The steam [27] that entered the pressure let-down turbine [26] at a higher pressure exits the turbine at a lower pressure [28], and is condensed as a part of pressure let-down turbine operation [28A], or is then used to meet process heating and/or wastewater reduction and water recovery needs for the plant as a stand-alone heat source [28B], or in conjunction with the higher temperature and higher pressure process steam from the MVR [28C]. In this latter case, the lower pressure steam from the let-down turbine may be sent to the higher pressure process vapor header [16] or kept separate from the process vapor to avoid boiler steam contamination.

Process condensate results when enough heat is recovered from the compressed process vapor that it condenses, converting the vapor to a liquid condensate. The resulting process condensate [29] is collected point by point [21] or combined for collection in a process condensate header [22]. The process condensate can then serve as a makeup source [29A] for the flash receiver [13] via process condensate makeup [24], used for de-superheating the compressed low pressure process vapors [16], returned [29B] to the existing facility process condensate collection system [30] or discharged to the facility wastewater treatment plant [29C]. Other options may also exist depending on the specific facility configuration.

### A Third Embodiment of a Waste Heat Integrated Recompression System

In another embodiment of the WHIR system, FIG. 3, which is a block diagram of the invention as applied to a dryer [5] at an alcohol plant or a seed oil extraction plant. Wet cake, meal or other biomass [2] either alone or mixed with slurry [3] is fed directly to a dryer [5] that is heated with natural gas, coal, wood, electricity or some other energy source [1], typically with some amount of air added to help remove moisture in the form of water vapor. The moisture laden air and other gases removed in the dryer are discharged directly to the atmosphere [8] or drawn through an exhaust draft fan [5B] that discharges [6] to a thermal oxidizer [7] and/or a direct contact heat exchanger [9] depending on whether it is desired to recover heat from a portion or all of the dryer exhaust. The low-temperature working fluid [12] entering the direct contact heat exchanger [9] from the flash receiver is heated by the sensible and latent heat available in dryer exhaust [6A]. Water vapor condensed [23] from the dryer exhaust flows from the direct contact heat exchanger [9] to a suitable collection point for, pre-conditioning the dryer exhaust upstream of the direct contact heat exchanger, disposal or refinement for reuse as needed.

The heated working fluid [11] enters the flash receiver [13] at a temperature higher than the working fluid leaving [12] the flash receiver, such that the enthalpy difference provides sufficient energy to convert a portion of the working fluid to low-pressure process vapor [14].

The low-pressure process vapor is drawn to the vacuum generating device [31], in this case, a steam driven thermal vapor recompressor (TVR) [32]. The pressure and temperature of the low pressure process vapor is increased by the vacuum generating device [31], and the resulting compressed vapor is distributed to a heat exchanger [18], which may be direct or indirect contact, to preheat a single process fluid [19], or to a low pressure process steam header [17] for distribution to a multiple of any type of suitable heat loads [25].

The high pressure boiler steam [27] that enters the TVR mixes with the process vapor so that both the process vapor and the boiler steam are intimately mixed, both becoming process vapor heat sources. The mixed stream can contain contaminants that typically make the mixed stream unsuitable for return to the plant boiler steam system, but this will be acceptable in some configurations. TVRs are typically less expensive to implement than MVRs, but have a lower operational efficiency compared to MVRs. The decision which type of recompressor is best for a particular plant often depends on the operational parameters of the plant.

Process condensate results when enough heat is recovered from the compressed process vapor that it condenses, converting the vapor to a liquid condensate. The resulting process condensate is collected point by point [21] or in a process condensate header [22]. The process condensate [29] can then serve as a makeup source [29A] for the flash receiver [13] via process condensate makeup [24], used for de-superheating the compressed low pressure process vapors [16], returned to the existing facility process condensate collection system [29B], or discharged to the facility wastewater treatment plant [29C]. Other options may also exist depending on the specific facility configuration.

### A Fourth Embodiment of a Waste Heat Integrated Recompression System

In another embodiment of the WHIR system, FIG. 4, which is a block diagram of the invention as applied to a dryer [5] at an alcohol plant or a seed oil extraction plant. Wet cake, meal or other biomass [2] either alone or mixed with slurry [3] is fed directly to a dryer [5] that is heated with natural gas, coal, wood, electricity or some other energy source [1], typically with some amount of air added to help remove moisture in the form of water vapor. The moisture laden air and other gases removed in the dryer are discharged directly to the atmosphere [8] or drawn through an exhaust draft fan [5B] that discharges [6] to a thermal oxidizer [7] and/or a direct contact heat exchanger [9] depending on whether it is desired to recover heat from a portion or all of the dryer exhaust. The low-temperature working fluid [12] entering the direct contact heat exchanger [9] from the flash receiver [13] is heated by the sensible and latent heat available in dryer exhaust [6A]. Water vapor condensed [23] from the dryer exhaust flows from the direct contact heat exchanger [9] to a suitable collection point for pre-conditioning the dryer exhaust upstream of the direct contact heat exchanger, disposal or refinement for reuse as needed.

The heated working fluid [11] enters the flash receiver [13] at a temperature higher than the working fluid leaving [12] the flash receiver, such that the enthalpy difference provides sufficient energy to convert a portion of the working fluid to low-pressure process vapor [14].

The low temperature, low pressure vapor [14] is drawn to the vacuum generating device [31], in this case, a combination of an electric motor driven mechanical vapor recompressor (MVR) [15] and a steam driven thermal vapor recompressor (TVR) [32]. A combination of this type can be in any particular order, can be used to minimize the pressure boost by the MVR, and thus the electric power requirements and cost of the recompressor, or to minimize the pressure boost by the TVR, and thus the boiler steam requirements and cost of operation. The MVR and TVR act in unison as a vacuum generating device to raise the pressure and temperature of the low temperature, low pressure process vapor. The resulting compressed vapor [16] is distributed to a heat exchanger [18], which may be direct or indirect contact, to preheat a single process fluid [19], or to a low pressure process steam header [17] for distribution to a multiple of any type of suitable heat loads [25].

The steam that enters the TVR [32] mixes with the process vapor [14] so that both the process vapor and the steam are intimately mixed, both becoming process heat sources. The mixed stream may contain contaminants that typically make the mixed stream unsuitable for return to the plant boiler steam system, but this will be acceptable in some configurations. As indicated above MVRs are more expensive than TVRs, but TVRs are typically less efficient than MVRs. By using both together an an optimal solution balancing energy recovery and cost of installation can be devised based on the needs of a particular facility.

It should be understood that while FIG. 4. Indicates that the TVR and MVR are near one another, this does not have to be the case. For example, the TVR could be located closer to the point of heat use, acting as a booster to the low-pressure process vapor compressed by the MVR.

Process condensate results when enough heat is recovered from the compressed process vapor that it condenses, converting the vapor to a liquid condensate. The resulting process condensate is collected point by point [21] or in a process condensate header [22]. The process condensate [29] can then serve as a makeup source [29A] for the flash receiver [13] via process condensate makeup [24], used for de-superheating the compressed low pressure process vapors [16], returned to the existing facility process condensate collection system [29B], or discharged to the facility wastewater treatment plant [29C]. Other options may also exist depending on the specific facility configuration.

### VARIATIONS AND ALTERNATIVE EMBODIMENTS

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A method of recovering heat from exhaust in an agricultural processing facility, the method comprising:
providing the agricultural processing facility, the facility including (i) various processing components for performing various facility processing operations, (ii) a boiler and boiler circuit configured to produce boiler quality steam and distribute the boiler quality steam to one or more processing components, (iii) a dryer configured to remove water in as water vapor from a biomass material; (iv) a direct contact heat exchanger operationally coupled to the dryer, (v) a flash receiver operationally coupled to the direct contact heat exchanger, and (vi) a working fluid, wherein the working fluid is distinct from and not introduced into the boiler circuit;
the dryer creating an exhaust containing water vapor;
transferring a working fluid having a lower temperature than the exhaust from flash receiver to the direct contact heat exchanger;
directing the exhaust from the dryer to the direct contact heat exchanger;
the exhaust and the working fluid coming into direct contact in the direct contact heat exchanger and heating the working fluid;
transferring heated working fluid to the flash receiver;
the flash receiver creating a process vapor from a portion of the working fluid wherein the working fluid is distinct from and is not added to the boiler circuit in the balance of the plant; and
providing the process vapor for use in the facility.

2. The method of claim 1, wherein the process vapor has a low temperature and low pressure relative to boiler quality steam.

3. The method of claim 1, wherein the agricultural processing facility comprises an ethanol production facility, a paper mill or a seed oil production facility.

4. The method of claim 1, wherein the agricultural processing facility further includes a vacuum generating device, and said providing the process vapor for use in the facility further includes transferring the process vapor to the vacuum generating device wherein the temperature and pressure of the process vapor is increased.

5. The method of claim 4, wherein the vacuum generating device comprises a mechanical vapor recompressor.

6. The method of claim 5, wherein the mechanical vapor recompressor is driven by a steam let-down turbine.

7. The method of claim 5, wherein the mechanical vapor recompressor is driven by an electrical motor.

8. The method of claim 4, wherein the vacuum generating device comprises a thermal vapor recompressor.

9. The method of claim 4, wherein the vacuum generating device comprises a combination of a thermal vapor recompressor and a mechanical vapor recompressor.

10. The method of claim 6, wherein boiler quality steam is used to power the mechanical vapor recompressor entering the steam pressure let-down turbine at a higher first pressure and exiting the let-down turbine at a lower second pressure.

11. The method of claim 10, wherein the boiler quality steam exiting the let-down turbine is used in the balance of the plant.

12. The method of claim 1, wherein the agricultural processing facility further comprises a makeup water source, the makeup water source being operatively coupled to the flash receiver and configured to provide makeup water to the working fluid.

13. The method of claim 10, wherein the agricultural processing facility further comprises a wastewater reduction and water recovery system, and the boiler quality steam exiting the let-down turbine is used in the wastewater reduction and water recovery system.

14. An agricultural processing facility comprising:
various processing components for performing various facility processing operations;
a boiler and boiler circuit configured to produce boiler quality steam and distribute the boiler quality steam to one or more processing components of the various processing components;
a dryer configured to remove water in vapor from a biomass material;
a direct contact heat exchanger operationally coupled to the dryer;
a flash receiver operationally coupled to the direct contact heat exchanger;
a working fluid, wherein the working fluid is distinct from and not in contact with boiler steam, boiler steam condensate or boiler feedwater, at least some of the working fluid contained within the flash receiver, the direct contact heat exchanger and fluid connections there between;
vacuum generating device with an inlet in fluid in communication with the flash receiver configured to receive process vapor created in the flash receiver from the working fluid, the vacuum generating device configured to compress the process vapor increasing the pressure and temperature thereof, and an outlet configured to release compressed process vapor to a fluid conduit; and
one or more other processing components of the various processing components in fluid connection with the one or more other processing components, the one or more other processing components not being in fluid communication with the boiler quality steam.

15. The agricultural processing facility of claim 14, wherein at least one of the one or more other processing components comprises a heat recovery unit.

16. The agricultural processing facility of claim 14, wherein at least one of the one or more other processing components comprises one or more of an indirect contact heat recovery unit, a dryer inlet air preheating unit, and a wastewater reduction and water recovery unit.

17. The agricultural processing facility of claim 14, wherein the vacuum generating device comprises an electric mechanical vapor recompressor.

18. The agricultural processing facility of claim 14, wherein the vacuum generating device comprises a steam let-down turbine driven mechanical vapor recompressor

19. The agricultural processing facility of claim 14, wherein the vacuum generating device comprises thermal vapor recompressor

20. The agricultural processing facility of claim 14, wherein the agricultural processing facility further comprises a makeup water source, the makeup water source being operatively coupled to the flash receiver and configured to provide makeup water to the working fluid.
